(19) United States
(12) Patent Application Publication
(10) Pub. No.: US 2004/0083575 A1
(43) Pub. Date: May 6, 2004

(54) Handle of a winch for a lashing rope

(76) Inventor: An-Chuan Chou, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/287,646

(22) Filed: Nov. 5, 2002

(51) Int. Cl. E05B 1/00

(52) U.S. Cl. 16/110.1

(57) ABSTRACT

A handle of a winch of a lashing rope includes a metallic tube part, two caps, and a soft plastic part. The plastic part is formed around a large portion of the tube part except for two ends of the tube part by means of injection molding. The tube part has a D-shaped cross-section for preventing rotary movement of the plastic part relative to it when the handle is being used. The handle is joined to two lever portions of a winch with two ends of the tube part being passed through respective D-shaped holes on the outward ends of the lever portions so that rotary movement of the tube part is prevented when the winch is being operated at the handle and the lever portions. The caps are joined to two ends of the tube part.

### BACKGROUND OF THE INVENTION

1. Field of the Invention

The present invention relates to a handle of a winch of a lashing rope, more particularly a handle of a lashing rope winch, of which the parts joined in such a manner that they can't fall loose easily to cause the winch to operate with reduced smoothness and convenience.

2. Brief Description of the Prior Art

Lashing rope winches are usually used for fastening cargo onto a truck with. Referring to FIG. 1, a conventional winch of a lashing rope includes a support base 1, an operating member 2, a shaft 3, and two ratchets 31.

The support base is provided with a connecting rod (not numbered), to which a first rope can be connected at one end. The first rope is connected to one side of the deck of a truck at the other end.

The shaft 3 is turnably supported on the support base 1 at two ends. A second rope is connected to the shaft 3 at one end, and connected to the opposite side of the truck deck at the other end. The ratchets 31 are connected to a respective end of the shaft 3 so that they can turn together with the shaft 21.

The operating member 4 is connected to the shaft 3 to be able to turn relative thereto, and has a handle 4, and an engaging plate (not numbered), which is biased to engage the ratchets 31 by an elastic member. Thus, the ropes can be stretched to fasten the cargo on the truck by means of pivoting the operating member 2 to and fro to make the second rope wound around the shaft 3.

Referring to FIGS. 2, and 3, a first conventional operating member includes two lever portions, and a handle 4. The lever portions have round connecting holes 22 at outer extensions 21 thereof. The handle 4 includes a metallic hollow cylindrical tube 42, and a soft plastic part 41, which is formed around a large portion of the cylindrical tube 42 except for two ends 421 of the tube 42 by means of injection molding. The two ends of the tube 42 are passed through respective round holes 22 of the lever portions, and struck flat so that the handle 4 is joined to the lever portions.

It is better for the handle 4 not to turn relative to the lever portions because if there is not rotary movement of the handle, the winch can be operated with more smoothness. Because the part 41 is made of plastics, and is formed around the tube 42 by means of injection molding, some adhesion can form between the part 41 and the tube 42 to prevent the plastic part 41 from turning relative to the tube 42. And, the tube 42 is joined to the lever portions with some firmness because the ends 421 of the tube 42 are struck into flat shape over outer side of the outer ends 21 of the lever portions.

However, the plastic part 41 is likely to come loose to move relative to the tube 42, and the tube 42 is likely to come loose to move relative to the lever portions in operating the winch because of the torque, which is exerted on the handle 4 when the operating member 2 is being moved to and fro. Consequently, the handle 4, which is held by the user's hand, will turn relative to the lever portions, causing reduction of smoothness and convenience of the operation.

### SUMMARY OF THE INVENTION

It is a main object of the present invention to provide a handle of a winch for a lashing rope, of which the parts joined in such a manner that they can't possibly fall loose when the winch is being operated.

It is another object of the present invention to provide ornamental caps to two ends of the present winch handle so that the handle is more pleasant-looking and attractive.

The handle of a winch of a lashing rope according to the present invention includes a metallic tube part, two caps, and a soft plastic part. The plastic part is formed around a large portion of the tube part except for two ends of the tube part by means of injection molding. The plastic part can be formed with a corrugated surface on a bottom. The tube part has a D-shaped cross-section so that rotary movement of the plastic part relative to the tube part is prevented when the handle is being used. The handle is joined to two lever portions of a winch with two ends of the tube part being passed through respective D-shaped holes of the lever portions so that rotary movement of the tube part is prevented when the winch is being operated at the handle and the lever portions. The caps are joined to two ends of the tube part, and made with various shapes and colors to match the plastic part.

### BRIEF DESCRIPTION OF THE DRAWINGS

The present invention will be better understood by reference to the accompanying drawings, wherein:

FIG. 1 is a perspective view of a conventional winch for a lashing rope as described in the Background,

FIG. 2 is a fragmentary exploded perspective view of the conventional winch for a lashing rope,

FIG. 3 is a cross-sectional view of a handle of the conventional winch for a lashing rope,

FIG. 4 is a fragmentary exploded perspective view of the winch for a lashing rope according to the present invention,

FIG. 5 is an exploded view of the handle of the winch for a lashing rope according to the present invention,

FIG. 6 is a cross-sectional view of the handle of the winch for a lashing rope according to the present invention; and,

FIG. 7 is a perspective view of the handle of the winch for a lashing rope according to the present invention.

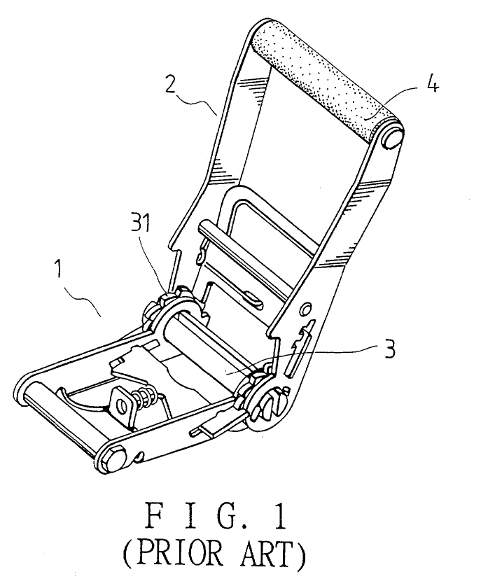

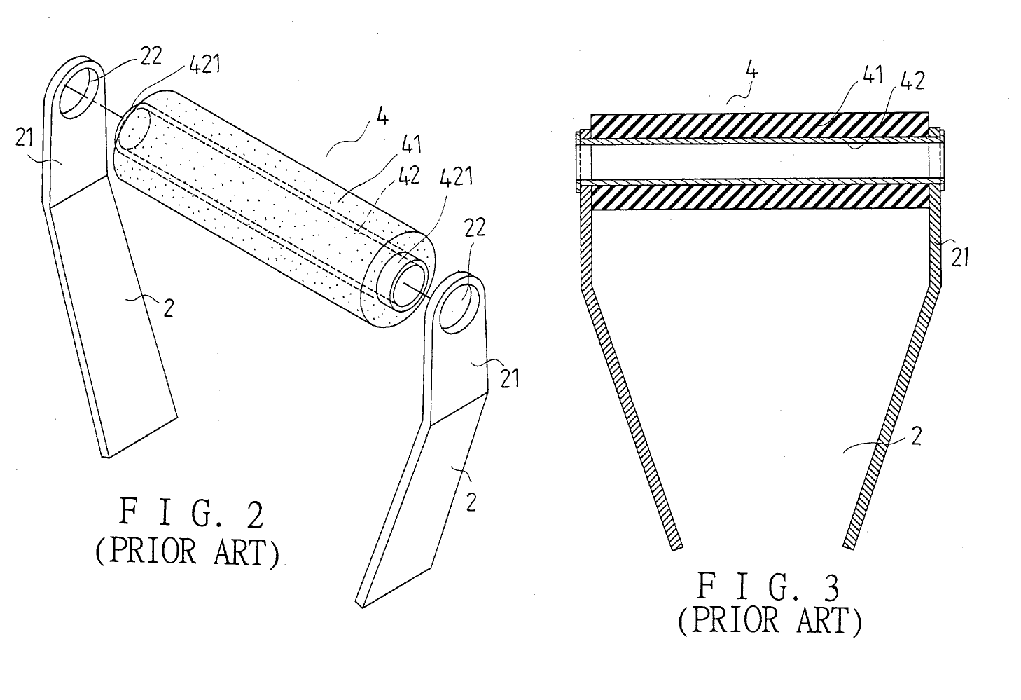

### DETAILED DESCRIPTION OF THE PREFERRED EMBODIMENTS

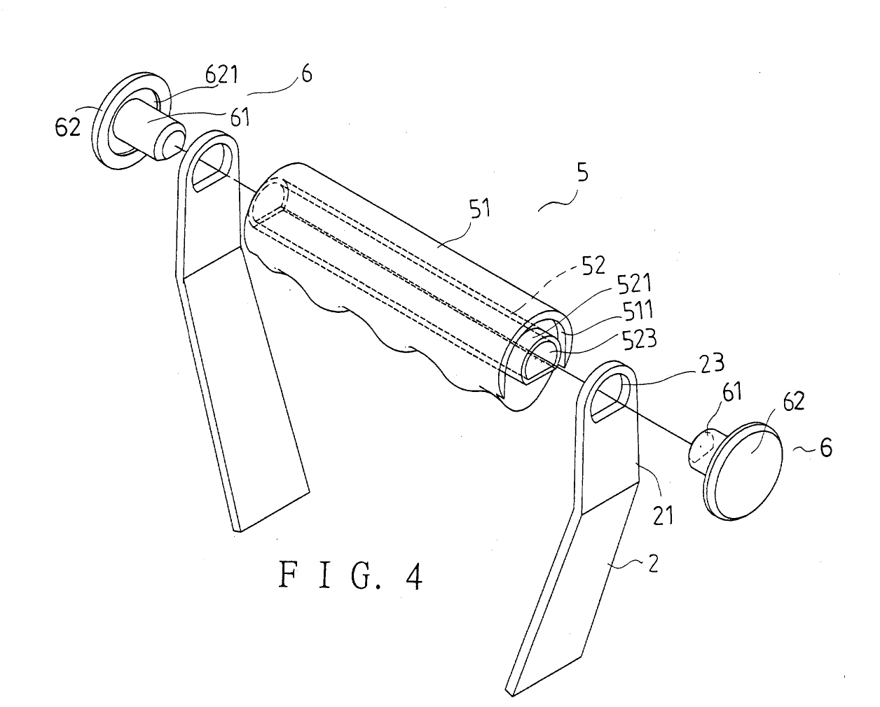

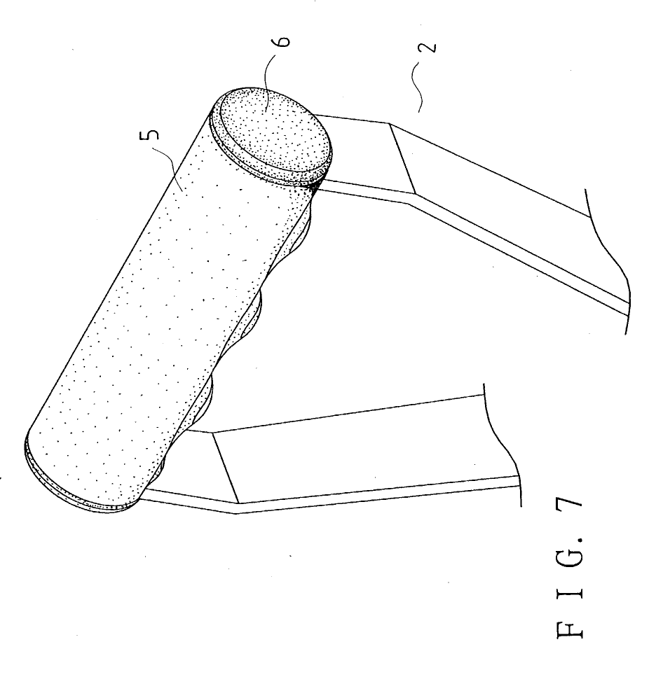

Referring to FIGS. 4 to 7, a handle 5 of a winch for a lashing rope of the present invention includes a hollow metallic tube part 52, a soft plastic part 51, and two ornamental caps 6.

The handle 5 is to be fastened to two lever portions of the operating member 2 of a winch, which is basically the same as the conventional one, and won't be detailed again here. Each of the lever portions has a D-shaped hole 23 on an outward end 21 thereof.

The tube part 52 is formed with a D-shaped cross-section, and a D-shaped hole 523 extending from one end to the other end thereof.

The plastic part 51 is formed around a large portion of the tube part 52 except for two ends 521 of the tube part 52 by means of injecting melted plastic material into a mold thereof, in which the tube part 52 has been disposed. In other words, two ends 521 of the tube part 52 stick out from the ends of the plastic part 51. The plastic part 51 is preferably made with a corrugated surface, and can be made various colors for providing the consumers with more choices. In addition, the soft plastic part 51 is formed with confining wall portions, which extend lengthwise from two ends of thereof so that holding rooms 511 are formed between the wall portions and upper and lateral sides of the ends 521 of the tube part 52.

Each of the caps 6 includes a covering portion 62, and an insertion portion 61, which has a D-shaped cross-section.

The handle 5 is joined to the outward ends 21 of the lever portions with the holding rooms 511 holding respective ones of the outward ends 21 of the lever portions therein, and with the ends 521 of the tube part 52 being passed through respective ones of the D-shaped holes 23. Those portions of the ends 521 of the tube part 52 that stick out from the D-shaped holes 23 are struck into flat shape to surround the edges of the D-shaped holes 23 on the outward sides of the lever portions. Thus, the tube part 52 can't possibly turn relative to the lever portions.

The covering portions 62 of the ornamental caps 6 can be made into various shapes and colors to match the plastic part 51. The ornamental caps 6 are joined to respective ends 521 of the tube part 52 with the insertion portions 61 thereof being closely inserted into two ends of the D-shaped hole 523, and with the covering portions 62 covering the holding rooms 511 and outward ends of the extended confining wall portions of the plastic part 51.

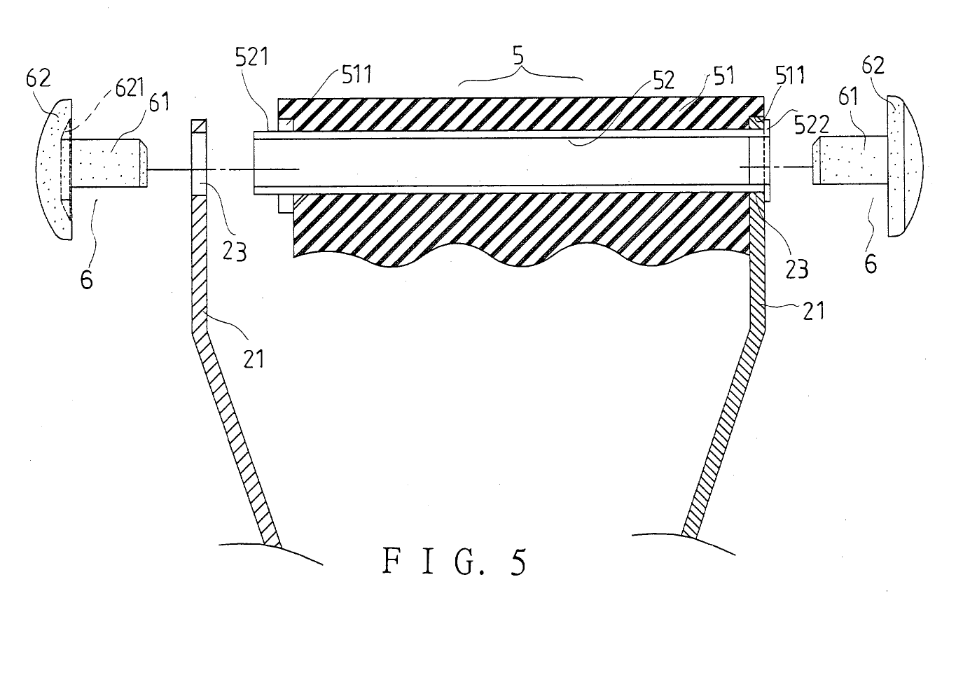

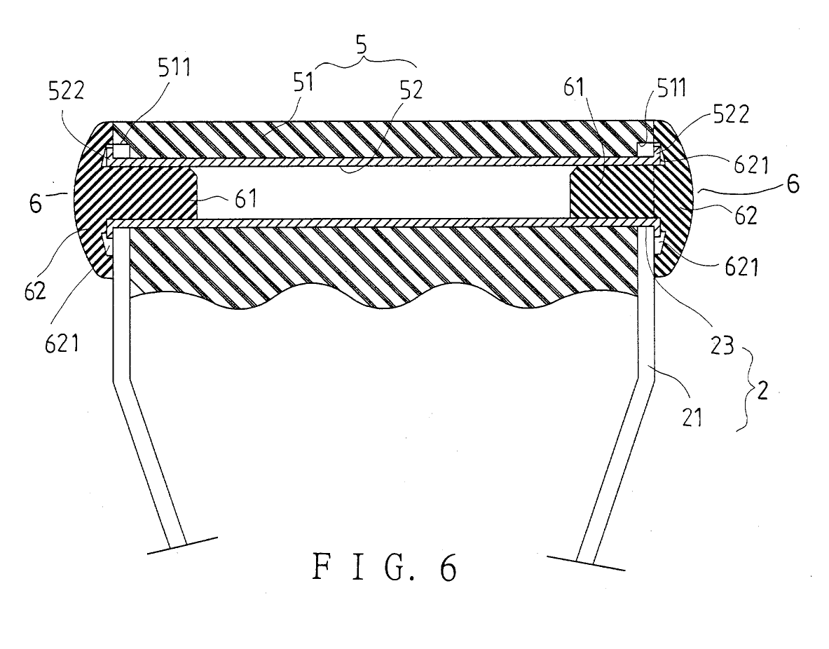

Furthermore, each of the ornamental caps 6 has a recess 621 around the insertion portion 61 on an inward side of the covering portion 62 thereof so that the struck flat portions 522 (FIG. 5) of the ends 521 of the tube part 52 can be hidden by means of the covering portions 62.

From the above description, it can be easily understood that the handle of a winch of a lashing rope according to the present invention has desirable features as followings:

1. The plastic part 51 can't possibly rotate about the tube part 52 because it is closely formed around the tube part 52 with adhesion being formed in between due to the method of making it, i.e. injection molding, and because the tube part 52 has a D-shaped cross-section instead of a round one. Therefore, the handle can stay in good shape even after long period of use and even if a large torque is exerted on it in operation of the winch.

2. The handle 5 can't possible rotate relative to the lever portions because the tube part 52 and the holes 23 of the lever portions have the same D shape, which two ends 521 of the tube part 52 is passed through for connection of the handle with the lever portions. Therefore, the operating member of the winch can't possibly fall loose even after long period of use, allowing the user to operate the winch smoothly.

3. The plastic part can be made with various desired shapes and colors for adding to attractiveness of the winch. The ornamental caps provided at two ends of the handle can also be formed with various desired shapes and colors to match the plastic part.

4. The handle has holding rooms 511 for allowing the outward ends 21 of the lever portions to be hidden in. And, the ornamental caps have recesses 621 to hide the struck portions of the ends 521 of the tube part 52 therein. Therefore, the appearance of the winch will not be badly affected by the joints between the handle and the lever portions.

What is claimed is:

1. A handle of a winch for a lashing rope, comprising
a tube part;
a soft plastic part, the plastic part being arranged closely around a large portion of the tube part except for two ends of the tube part; the soft plastic part having confining wall portions extending lengthwise from two ends thereof to define holding rooms between the wall portions and upper and lateral sides of respective ends of the tube part; and,
two caps each including a covering portion, and an insertion portion;
the tube part having a D-shaped cross-section for preventing rotary movement of the plastic part relative to it when the winch is being used; the tube part having a D-shaped hole extending from one end to other end thereof,
the handle being joined to two lever portions of a winch with outward ends of the lever portions being held in the holding rooms, and with two ends of the tube part being passed through respective D-shaped holes formed on the outward ends of the lever portions, and with those portions of the tube part that stick out from outward sides of the lever portions being struck into flat shape to surround edges of the D-shaped holes of the lever portions on the outward sides of the lever portions so that rotary movement of the tube part is prevented when the winch is being operated at the handle and the lever portions;
the caps being joined to respective ends of the tube part with the insertion portions thereof being inserted into the D-shaped holes of the tube part, and with the covering portions coveting the holding rooms and outward ends of the confining wall portions of the plastic part; the insertion portions being formed with D-shaped cross-section to fit closely into respective D-shaped holes of two ends of the tube part.

2. The handle of a winch for a lashing rope as claimed in claim 1, wherein each of the caps having a recess around the insertion portion on an inward side of the covering portion thereof for allowing the struck flat portions of the ends of the tube part to be hidden therein.
